(19) United States
(12) Patent Application Publication
(10) Pub. No.: US 2005/0169645 A1
(43) Pub. Date: Aug. 4, 2005

(54) Adjustable dynamic range optimization for analog to digital resolution for intelligent fiber optic receivers and method

(75) Inventor: Nelson Diaz, Westminster, CO (US)

Correspondence Address: Dicke, Billig & Czaja, PLLC, Fifth Street Towers, Suite 2250, 100 South Fifth Street, Minneapolis, MN, 55402, US

(73) Assignee: Infineon Technologies North America Corp.

(21) Appl. No.: 10/767,376

(22) Filed: Jan. 29, 2004

(51) Int. Cl. H04B 10/06

(52) U.S. Cl. 398/202

(57) ABSTRACT

A receiver in a fiber optic system including an optical detector, an electronic circuit and an adjustment input circuit. The optical detector is configured to receive optical signals of varying light intensity. The optical detector has a dynamic range of sensitivity between a high optical intensity value and a low optical intensity value. The optical detector is also configured to convert the received optical signals into analog electrical signals proportional to the optical intensity of the optical signals. The electronic circuit is coupled to the optical detector and it is configured to receive the analog electrical signals from the optical detector. The electronic circuit also produces digital signals representative of the optical intensity of the optical signals such that the electronic circuit is configured with an original maximum digital value proportional to the high optical intensity value and an original minimum digital value proportional to the low optical intensity value. This defines an original receiver resolution between the original minimum and maximum digital values. The adjustment input circuit is coupled to the electronic circuit and is configured to allow the original maximum digital value to be adjusted to an adjusted maximum digital value. It is also configured to allow the original minimum digital value to be adjusted to an adjusted minimum digital value. This defines an adjusted receiver resolution between the adjusted minimum and maximum digital values.

### BACKGROUND

This invention relates to a receiver in a fiber optic system. The receiver range endpoints are adjusted to optimize the resolution of the receiver without increasing the number of output bits.

Fiber optic systems generally have three main components, a transmitter, a channel, and a receiver. Fiber optic systems use light pulses to transmit information through fiber cables, which are then received and generally translated to electrical signals. Optical receivers generally receive and convert a modulated light signal coming from the optical fiber back into a replica of the original signal, which was applied to the transmitter.

A receiver generally includes an optical detector and related electrical circuitry. The optical detector receives an optical signal from the optical fiber and converts the optical signal into a modulated electrical signal proportional to the optical signal.

Recently, fiber optic systems have become increasingly highly integrated systems with high performance demands at relatively low cost. Optical receivers in such systems are required to receive and convert optical signals into very small currents indicative of the optical signals received. In such optical fiber systems, the optical receiver may be required to receive and convert optical signals over a large range of optical intensity (“dynamic range”). For example, where a plurality of geographically distributed users each write on to a common optical fiber, incoming optical signals from a nearby transmitter may be detected at a high signal level, whereas incoming optical signals from a distant transmitter may be detected at very low signals levels. Consequently, a system receiver must be able to detect all levels of signals and transmit these signals without loss of signal bandwidth and with relatively low bit error rates.

### SUMMARY

The present invention is a receiver for use in a fiber optic system. The receiver includes an optical detector, an electronic circuit and an adjustment input circuit. The optical detector is configured to receive an optical signal of varying light intensity. The optical detector has a dynamic range of sensitivity between a high optical intensity value and a low optical intensity value. The optical detector is also configured to convert the received optical signal into an analog electrical signal proportional to the optical intensity of the optical signal. The electronic circuit is coupled to the optical detector and it is configured to receive the analog electrical signal from the optical detector. The electronic circuit also produces digital signals representative of the optical intensity of the optical signal such that the electronic circuit is configured with an original maximum digital value proportional to the high optical intensity value and an original minimum digital value proportional to the low optical intensity value. This defines an original receiver resolution between the original minimum and maximum digital values. The adjustment input circuit is coupled to the electronic circuit and is configured to allow the original maximum digital value to be adjusted to an adjusted maximum digital value. It is also configured to allow the original minimum digital value to be adjusted to an adjusted minimum digital value. This defines an adjusted receiver resolution between the adjusted minimum and maximum digital values.

### BRIEF DESCRIPTION OF THE DRAWINGS

The accompanying drawings are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated as they become better understood by reference to the following detailed description. The elements of the drawings are not necessarily to scale relative to each other. Like reference numerals designate corresponding similar parts.

FIG. 1 illustrates a fiber optic system.

FIG. 2 illustrates a receiver in a fiber optic system.

FIG. 3A illustrates an initial digital range in a receiver in accordance with the present invention.

FIG. 3B illustrates an adjusted digital range in a receiver in accordance with the present invention.

FIG. 4 illustrates an exemplary flow diagram of an optimization method in accordance with the present invention.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

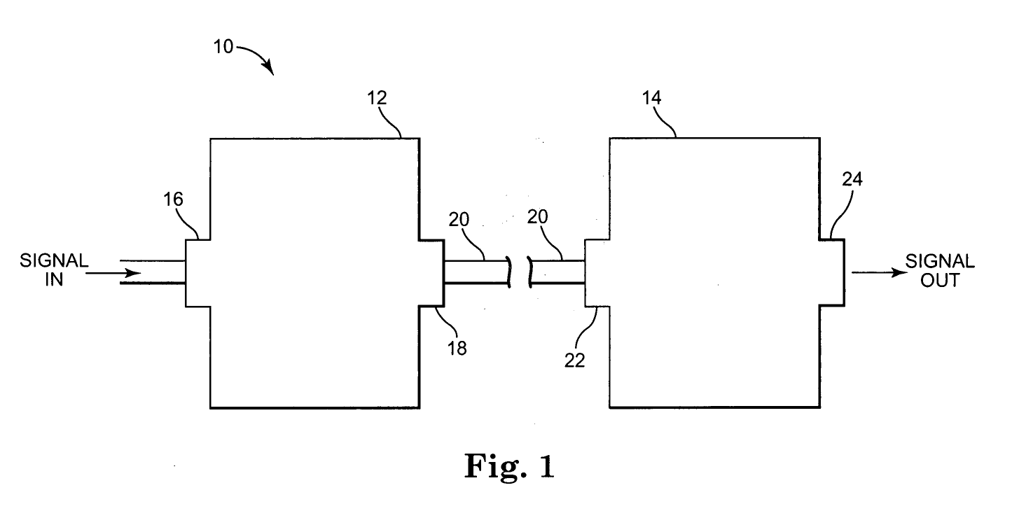

FIG. 1 illustrates fiber optic system 10. A fiber optic system 10 includes transmitter 12, receiver 14, electrical input connector 16, optical connectors 18 and 22, optical fiber 20, and output signal connector 24. In operation, transmitter 12 is coupled to an information source by input connector 16. The information source transfers information via a modulated electrical signal, which is coupled to electrical connector 16 and then to transmitter 12. Transmitter 12 contains a light source, typically a LED or a laser. The light source is driven by the electrical signal received by transmitter 12. This generates a modulated optical signal which is then transmitted to optical fiber 20.

Optical fiber 20 generally includes a cylindrical core, a concentric cylindrical cladding surrounding the core, and a concentric cylindrical protective jacket or buffer surrounding the cladding. The core is made of transparent glass or plastic having a certain index of refraction. The cladding is also made of transparent glass or plastic, but having a different, smaller, index of a fraction. Optical fiber 20 acts as a bendable waveguide and its characteristics are largely determined by the relative refractive indices of the core and the cladding. The optical fiber 20 can be routed over distances such that transmitter 12 and receiver 14 may be located in distant locations relative to each other.

Optical fiber 20 is coupled to receiver 14 via optical connector 22. Receiver 14 includes an optical detector and related electronic circuitry. The optical signal received by receiver 14 is converted to an electrical signal by the optical detector and processed by the electrical circuitry to a suitable format for output signal at output connector 24. The modulated light signal coming from the optical fiber 20 and received by receiver 14 is converted back into a replica of the original signal, which was applied to the transmitter 12.

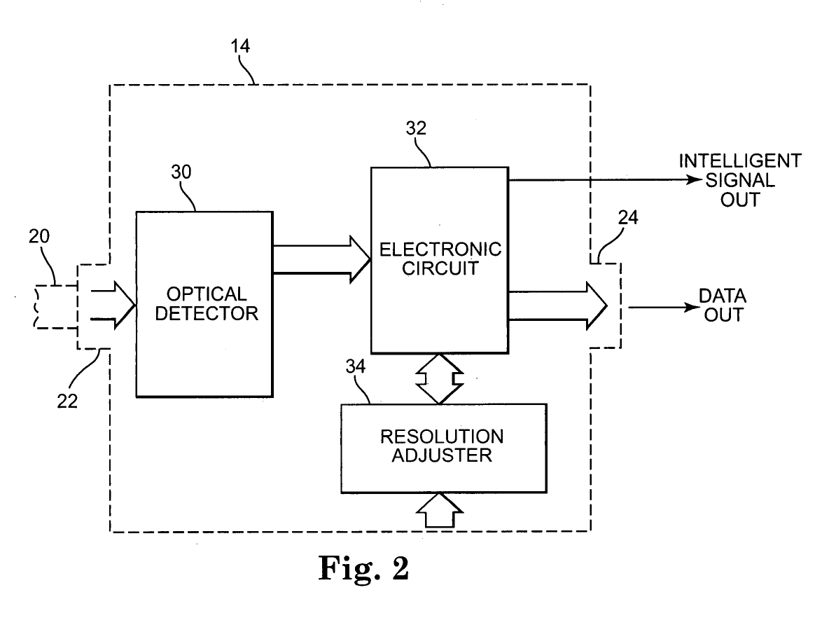

FIG. 2 illustrates an exemplary implementation receiver 14 in accordance with the present invention. Receiver 14 includes optical detector 30, receiver electronic circuit 32, and resolution adjustor 34. Receiver 14 is coupled to optical fiber 20 via optical connector 22. Receiver 14 generates a data output signal at data output 24. In operation, receiver 14 converts the modulated light signals coming from the optical fiber 20 back into a replica of the original electrical signal applied to transmitter 12.

In one embodiment of fiber optic system 10, receiver 14 is a small form-factor pluggable module (SFP) that is a one-piece unit that is easily installed into fiber optic system 10. Furthermore, receiver 14 is an intelligent small form-factor pluggable module (ISFP) that monitors some of the system parameters, such as the amount of optical power coming into the receiver, the power output from the transmitter and the temperature. It also generates an intelligent output signal indicative of these parameters.

Receiver 14 includes optical detector 30, which is configured to detect the modulated optical signal from optical fiber 20. Typically, optical detector 30 is a photodiode of either a PIN or avalanche type. Optical detector 30 has a relatively large sensitive detecting area that can be several hundred microns in diameter. Consequently, optical signals from optical fiber 20 can be easily detected by optical detector 30. When the optical signal reaches optical detector 30, optical detector 30 converts the optical energy, in the form of photons, into electrical energy. The output of optical detector 30 is a flow of electrical current that is proportional to the received optical power signal. This electrical current is then received by receiver electronic circuit 32 for further processing.

Typically, receiver electronic circuit 32 includes a current mirror for monitoring the current coming from the optical detector 30. It may also include operational amplifiers, since the incoming current can be very small. A current-to-voltage converter then converts the current to a voltage, and an analog-to-digital converter converts the voltage magnitude into digital format and produces a data out signal. In this way, the data out signal from receiver electronic circuit 32 is a digital signal representative of the received optical power from optical fiber 20, which in turn is proportional to the original electrical signal applied to transmitter 12. Accordingly, the digital data signal out of receiver 14 at connector 24 is representative of the original electrical signal applied to transmitter 12.

Optical detector 30 is configured to receive the optical signal of varying optical power or intensity. Once configured in receiver 14, optical detector 30 will have minimum and maximum optical power sensing capability. The difference between the lowest and the highest optical power value that a sensor is capable of detecting is the “dynamic range” of the sensor. For a typical fiber optic system 10, receiver 14 will have an expected dynamic range to accommodate optical signals that will vary in power over time. Consequently, receiver 14 must be selected such that the dynamic range of its optical detector will accurately convert all optical signals received over optical fiber 20 in fiber optic system 10.

In an fiber optic system where, for example, a plurality of geographically distributed users each write onto a common optical fiber, incoming optical signals from a nearby transmitter may be detected at a relatively high signal level, whereas incoming signals from a distant transmitter may be detected at relatively low signal levels. Consequently, in order to be effective, optical detector 30 of receiver 14 must be able to detect all levels of signals and transmit these signals without loss of signal bandwidth. Thus, optical detector 30 has a dynamic range between a high optical value and a low optical value. In one embodiment of fiber optic system 10, receiver 14 has an optical detector 30 with a dynamic range between −20 dBm and +7 dBm. Thus, once receiver 14 is installed in fiber optic system 10, it is expected that optical signals reaching optical detector 30 will never be less than −20 dBm and never more than +7 dBm. One skilled in the art will recognize that a variety of range sensitivities are usable for a receiver.

Receiver electronic circuit 32 is configured to receive the flow of electrical current from optical detector 30. The received current is proportional to the received optical power. Receiver electronic circuit 32 further includes an analog-to-digital converter that is configured to receive the electrical current from the optical detector 30 that is proportional to the received optical power. Just as optical detector 30 has a dynamic range between the high optical value and the low optical value, this analog-to-digital converter is configured to have an original high end digital range value corresponding to the high optical value and an original low end digital range value corresponding to the low optical value. The analog-to-digital converter within receiver electronic circuit 32 converts the received analog signal to a series of digital signals over time to produce an intelligent signal out. Intelligent signal out is indicative of the optical intensity of the optical signals received by receiver 14.

The optical signals received by receiver 14 have varying optical power with respect to time. Accordingly, the analog signal received by the analog-to digital converter within receiver electronic circuit 32 also varies over time. The analog-to-digital converter within receiver electronic circuit 32 is configured to produce digital values that represent the analog signal, and thus, optical signal power, as it changes over time. Thus, the relative magnitude of the optical intensity or of the power of the signal corning into receiver 14 is represented at various points in time by a discrete number of digital values as the intelligent signal out. The number of digital values that represent the optical power is determined by the number of bits used in the analog-to-digital converter within receiver electronic circuit 32. For example, if the analog-to-digital converter is a four-bit analog-to-digital converter, there are 16 values that represent the magnitude of the optical power. If it were an eight-bit analog-to-digital converter, then there are 256 values that represent the magnitude of the optical power, and so on.

Initially, the analog-to-digital converter within receiver electronic circuit 32 is set such that its highest digital value corresponds to the high optical value and such that the lowest digital value corresponds to the low optical value. This is the initial or original digital range of the receiver 14. Receiver 14 also includes resolution adjuster circuit 34, which is used to adjust the resolution of receiver 14. If it is known that the actual optical signals that will be received by receiver 14 vary over a smaller range than is detectable by optical detector 30, then the digital range of receiver 14 can be adjusted accordingly by using resolution adjuster circuit 34 to adjusting the analog-to-digital converter within receiver electronic circuit 32 in order to provide better or finer resolution.

For example, if an optical detector 30 has a dynamic range between negative 20 dBm and positive 7 dBm, but in a particular application for fiber optic system 10 it is known that the actual optical signals received by receiver 14 will be between negative 15 dBm and 0 dBm, then the digital range of receiver 14 can be adjusted using resolution adjuster circuit 34, thereby improving the resolution of receiver 14.

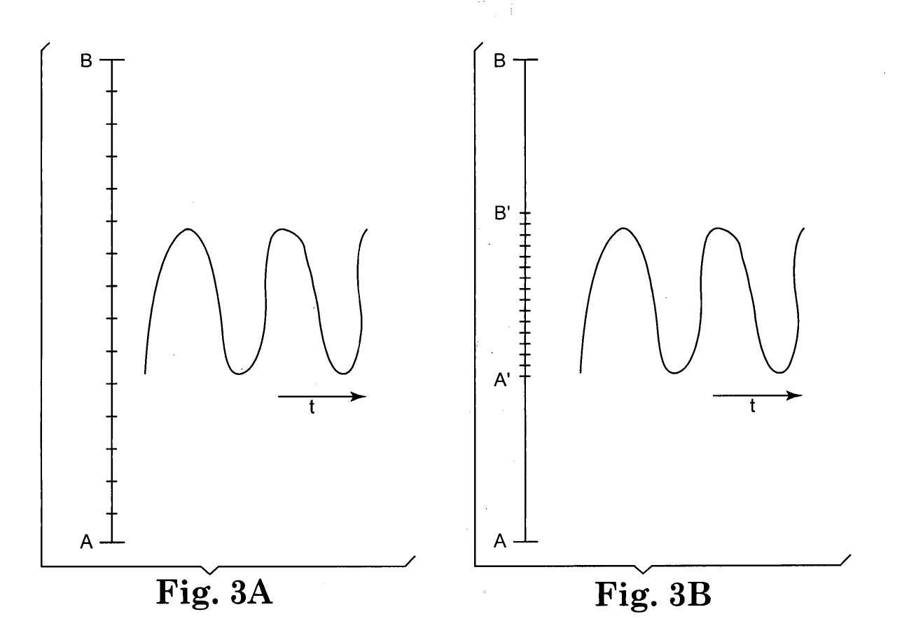

FIGS. 3A and 3B illustrate a resolution adjustment and optimization in accordance with the present invention. FIG. 3A illustrates the analog electrical signal that has been transferred from optical detector 30 to electronic circuit 32. The analog electrical signal has a varying magnitude with respect to time (t). Points A and B shown on the vertical axis in FIG. 3A illustrate the minimum and maximum, respectively, of the initial or original digital range for the analog-to-digital converter within receiver electronic circuit 32. Each of the divisions illustrated in the vertical axis of the figure are discrete digital data points that can represent the signal value at a given point in time. These steps in the initial digital range define the initial resolution of receiver 14.

Points A′ and B′ shown on the vertical axis in FIG. 3A illustrate the minimum and maximum, respectively, of the adjusted or modified digital range for the analog-to-digital converter within receiver electronic circuit 32. Each of the divisions shown in the figure illustrate discrete digital data points that can represent the signal value at a given point in time. Points A and B are also shown on the vertical axis in FIG. 3B for relative comparison. As is evident from the figures, adjusting the minimum and maximum values of the digital range provides smaller steps in the range and thereby provides better or finer resolution. Thus, when it is known that the optical signals actually received by optical detector 30 will have an optical intensity that varies over a smaller range than the dynamic range of optical detector 30, then the electrical analog signal received by the receiver electronic circuit 32 will correspondingly vary over a smaller range than the initial digital range. Thus, the digital range of the analog-to-digital converter within receiver electronic circuit 32 can be adjusted to provide better resolution for receiver 14, since the full range is not needed.

FIGS. 3A and 3B illustrate the analog-to-digital converter within receiver electronic circuit 32 as a 4-bit analog-to-digital converter. Thus, in FIGS. 3A and 3B, there are 16 steps that can represent the magnitude of the signal. In the illustration, the electrical signal varies in a center portion of the original digital range illustrated in FIG. 3A. Thus, FIG. 3B illustrates an adjusted digital range that moves the minimum and maximum values in the range closer to the actual minimum and maximum values of the actual signal received by the analog-to-digital converter within receiver electronic circuit 32. This provides a range more closely tailored to the received electrical signal, and thus, provides a better or finer resolution. Where the width of the steps in FIG. 3A are (A−B)/4-bits, the width of the steps in FIG. 3B are (A′−B′)/4-bits. The difference between A and B is significantly larger than the difference between A′ and B′. Accordingly, the steps in the modified digital range illustrated in FIG. 3B are smaller and provide better resolution for receiver 14.

FIGS. 3A and 3B illustrate digital data points that are represented by 4-bit digital values. One skilled in the art will recognize that other size digital values can be used, such as 2, 6, 8, 16-bit words, by implementing 1, 6, 8, 16, or larger analog-to-digital converters. There will be more steps of resolution available when more bits are used in each word, but the relative number of steps in the modified digital range can always be adjusted to be more than in the original digital range.

Resolution adjusted circuit 34 can be implemented in a variety of ways consistent with the present invention. For example, a variety of resistor networks and switches could be used to make adjustments. Similarly, programmable read only memory devices could be used to make adjustments to the digital range. One skilled in the art will recognize that many similar implementations would be available to allow adjustments to the digital range to improve the resolution of receiver 14. Furthermore, the analog-to-digital converter within receiver electronic circuit 32 can be implemented in a variety of ways consistent with the present invention. There could be any number of analog-to-digital converters implemented within receiver electronic circuit 32 in a any number of a variety of forms.

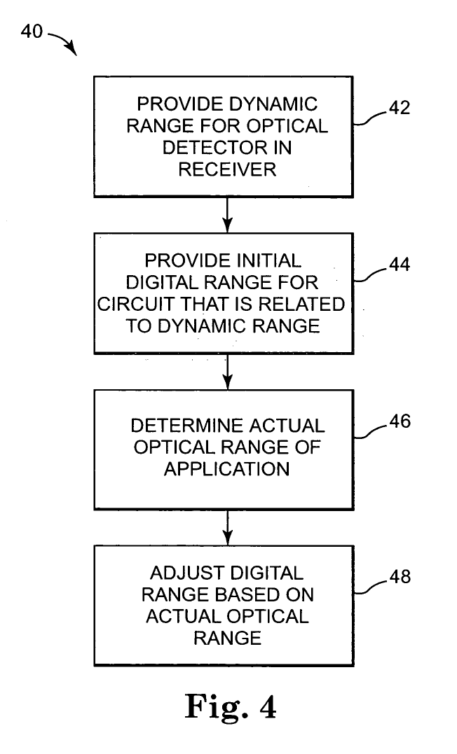

In FIG. 4, a flow diagram illustrating one exemplary embodiment of a method in accordance with the present invention is shown generally at 40. In step 42 an optical detector with a dynamic range sensitivity is provided. The dynamic range of the optical detector is defined between a highest optical value and a lowest optical value. In step 44 an initial digital range is provided for an electronic circuit. The initial digital range is representative of the dynamic range and defined between an initial maximum digital value and an initial minimum digital value. In step 46 an actual optical range required for a particular fiber optic system application is determined. The actual optical range is defined between a highest actual optical value and a lowest actual value. In step 48 the initial digital range is adjusted based on the actual optical range. In one embodiment, this adjustment is made such that the adjusted maximum digital value is proportional to highest actual optical value and the adjusted minimum digital value is proportional to lowest actual optical value.

Although specific embodiments have been illustrated and described herein, it will be appreciated by those of ordinary skill in the art that a variety of alternate and/or equivalent implementations may be substituted for the specific embodiments shown and described without departing from the scope of the present invention. For example, although the present invention has been described such that the resolution of the receiver is adjusted to decrease the range, it can be seen that the original range could be smaller, and then adjusted to be increased to accommodate optical signals of larger intensity than originally accommodated. This application is intended to cover any adaptations or variations of the specific embodiments discussed herein. Therefore, it is intended that this invention be limited only by the claims and the equivalents thereof.

1. A receiver in a fiber optic system configured to receive an optical signal of varying light intensity and to produce a data output signal proportional thereto, the receiver comprising:
an optical detector configured to receive the optical signal, the optical detector having a dynamic range of sensitivity between a high optical intensity value and a low optical intensity value, the optical detector further configured to convert the received optical signal into an analog electrical signal proportional to the optical intensity of the optical signal;
an electronic circuit coupled to the optical detector, the electronic circuit configured to receive the analog electrical signal from the optical detector and to produce digital signals representative of the optical intensity of the optical signal such that the electronic circuit is configured to have an original maximum digital value proportional to the high optical intensity value and an original minimum digital value proportional to the low optical intensity value thereby defining an original receiver resolution between the original minimum and maximum digital values; and
an adjustment circuit coupled to the electronic circuit configured to allow the original maximum digital value to be adjusted to an adjusted maximum digital value and to allow the original minimum digital value to be adjusted to an adjusted minimum digital value thereby defining an adjusted receiver resolution between the adjusted minimum and maximum digital values.

2. The receiver of claim 1 wherein the adjusted maximum digital value is different than the original maximum digital value.

3. The receiver of claim 1 wherein the adjusted minimum digital value is different than the original minimum digital value.

4. The receiver of claim 1 wherein the adjusted maximum digital value is lower than the original maximum digital value and the adjusted minimum digital value is higher than the original minimum digital value such that the adjusted receiver resolution is finer than the original receiver resolution.

5. The receiver of claim 1 wherein the adjusted maximum digital value is proportional to a highest anticipated optical value for the optical signal received by the optical detector and wherein the adjusted minimum digital value is proportional to a lowest anticipated optical value of the optical signal received by the optical detector.

6. The receiver of claim 1 wherein the adjusted maximum digital value is less than the original maximum digital value and is proportional to a highest anticipated optical value for the optical signal received by the optical detector and wherein the adjusted minimum digital value is higher than the original minimum digital value is proportional to a lowest anticipated optical value of the optical signal received by the optical detector.

7. The receiver of claim 1 wherein the dynamic range of sensitivity is between a high optical intensity value of positive 7 dBm and a low optical intensity value of negative 20 dBm.

8. The receiver of claim 1 wherein the electronic circuit includes an analog-to-digital converter configured to receive the analog electrical signal and to convert the electrical signal into digital signals.

9. The receiver of claim 8 wherein the analog-to-digital converter converts the analog electrical signal into a series of 8-bit digital values.

10. The receiver of claim 9 wherein the lowest 8-bit digital value is originally the original minimum digital value and then adjusted to the adjusted minimum digital value, and wherein the highest 8-bit digital value is originally the original maximum digital value and then adjusted to the adjusted maximum digital value.

11. The receiver of claim 1 assembled into a intelligent small form factor pluggable module for use with a fiber optic system.

12. A fiber optic communication system comprising:
a signal transmitter that produces optical signals of varying light intensity;
an optical fiber coupled to the signal transmitter that receives and transmits the optical signals;
a receiver coupled to the optical fiber that receives the optical signals and produces a data signal proportional thereto, the receiver further comprising:
an optical detector configured to receive the optical signals, the optical detector having a dynamic range of sensitivity between a high optical value and a low optical value, the optical detector further configured to convert the received optical signals into electrical signals proportional to the optical intensity of the optical signals;
an electronic circuit coupled to the optical detector, the electronic circuit configured to receive the electrical signals from the optical detector and to have an initial digital range representative of the dynamic range, the initial digital range being defined between an initial maximum digital value and an initial minimum digital value, the initial maximum digital value being proportional to high optical value and the initial minimum digital value being proportional to low optical value; and
an adjustment circuit coupled to the electronic circuit configured to allow the initial maximum digital value to be adjusted to an adjusted maximum digital value and to allow the initial minimum digital value to be adjusted to an adjusted minimum digital value thereby defining an adjusted digital range, the adjusted maximum digital value being proportional to a highest anticipated optical value and the adjusted minimum digital value being proportional to a lowest anticipated optical value.

13. The fiber optic communication system of claim 12 wherein the adjusted maximum digital value is different than the initial maximum digital value.

14. The fiber optic communication system of claim 12 wherein the adjusted maximum digital value is lower than the initial maximum digital value and the adjusted minimum digital value is higher than the initial minimum digital value such that the adjusted digital range has more steps than the initial digital range.

15. The fiber optic communication system of claim 12 wherein the electronic circuit includes an analog-to-digital converter configured to receive the analog electrical signal and to convert the electrical signal into a digital signal.

16. The fiber optic communication system of claim 12 wherein the receiver is assembled into an intelligent small form factor pluggable module for use in the fiber optic system.

17. A receiver in a fiber optic system, the receiver comprising:
an optical detector configured to receive an optical signal of varying light intensity, the optical detector having a dynamic range of sensitivity between a high optical intensity value and a low optical intensity value, the optical detector further configured to convert the received optical signal into an analog electrical signal proportional to the optical intensity of the optical signal;
an electronic circuit coupled to the optical detector, the electronic circuit configured to receive the analog electrical signal from the optical detector and to produce digital signals representative of the optical intensity of the optical signal such that the electronic circuit is configured with an original maximum digital value proportional to the high optical intensity value and an original minimum digital value proportional to the low optical intensity value thereby defining an original receiver resolution between the original minimum and maximum digital values; and
adjustment means coupled to the electronic circuit for adjusting the original maximum digital value to an adjusted maximum digital value and for adjusting the original minimum digital value to an adjusted minimum digital value thereby defining an adjusted receiver resolution between the adjusted minimum and maximum digital values.

18. A method of adjusting the resolution of a receiver in a fiber optic system, the method including the steps of:
providing an optical detector with a dynamic range sensitivity between a highest optical value and a lowest optical value;
providing an initial digital range representative of the dynamic range, the initial digital range being defined between an initial maximum digital value and an initial minimum digital value, the maximum digital value being proportional to highest optical value and the minimum digital value being proportional to lowest optical value;
determining an actual optical range for a fiber optic system application, the actual optical range defined between a highest actual optical value and a lowest actual value; and
adjusting the initial digital range to an adjusted dynamic range, the adjusted digital range being defined between an adjusted maximum digital value and an adjusted minimum digital value, the adjusted maximum digital value being proportional to highest actual optical value and the adjusted minimum digital value being proportional to lowest actual optical value.

19. The method of claim 18 wherein the step of adjusting the initial digital range to an adjusted dynamic range includes adjusting the maximum digital value to be lower than the initial maximum digital value such that the adjusted digital range has more steps than the initial digital range.

20. The method of claim 18 wherein the step of adjusting the initial digital range to an adjusted dynamic range includes adjusting the minimum digital value to be higher than the initial minimum digital value such that the adjusted digital range has more steps than the initial digital range.
